(19) United States
(12) Patent Application Publication
(10) Pub. No.: US 2015/0379466 A1
(43) Pub. Date: Dec. 31, 2015

(54) PRODUCT CONFIGURATION GENERATING DEVICE, CONFIGURATION GENERATING METHOD, AND PROGRAM

(71) Applicant: HITACHI, LTD., Chiyoda-ku, Tokyo (JP)

(72) Inventors: Kentaro TAGUCHI, Tokyo (JP); Akihisa TSUJIBE, Tokyo (JP); Takanari INOUE, Tokyo (JP)

(21) Appl. No.: 14/768,227

(22) PCT Filed: Dec. 6, 2013
(86) PCT No.: PCT/JP2013/082871

§ 371 Date: Aug. 17, 2015

(51) Int. Cl. G06Q 10/08

(52) U.S. Cl. CPC G06Q 10/0875

(57) ABSTRACT

A BOM of a product which is used at a plurality of sites is acquired from a BOM input unit. With respect to each component configuration in the BOM, specifications with variations in past demand at or above a given level are accepted as variation specification information. On the basis of the variation specification information, the component specification to be segmented is extracted from the BOM and a BOM to be changed is generated. On the basis of the BOM to be changed, the component configuration of the

BOM is segmented and reconfigured, a changed BOM is generated, and the changed BOM is outputted.

### TECHNICAL FIELD

The present invention relates to a method and apparatus for generating a component configuration (BOM: Bills of Materials) of a product.

### BACKGROUND ART

A BOM is component table used for a product and is popularly used in estimation, design, procurement, fabricating, purchase, service, and the like. Manufacturing BOMs are used in all steps of fabricating and constructing products on the basis of design BOM mainly in a factory.

Products to which BOMs are applied include a large number of components such as units and substrates. When an information processing device is given as an example, products of a plurality of machine types configured by memories which are different from each other in performance and price are prepared in advance, and products of machine types suitable for various requests of respective end users are sold.

As a conventional technique which employs the manufacturing BOM, a BTS (Build To Stock) method and a CTO (Configure To Order) method are known. FIG. 12 is a diagram showing an example of a method of fabricating a product using BOM according to the conventional methods and the method of the present invention. In the BTS method (see a column of the BTS method) in FIG. 12, on the basis of the manufacturing BOM, in one factory serving as a site, with respect to all certain products X and Y, intermediate products A to C and J are fabricated from components D to I and K, and the products X and Y are finally assembled from the intermediate products. All the products are stored in a storehouse, a distribution center (DC: Distribution Center), or a delivery center (to be simply referred to as a DC hereinafter) near end users, inventory control is performed, and order allocations of the machine types are performed in response to customer requests related to the products.

On the other hand, in the CTO method (see a column of the CTO method) in FIG. 12, in one factory (factory 1) serving as a site, with respect to all the number of certain products X and Y, after intermediate products A to C and J are fabricated from the products D to I and K and the products X and Y are fabricated, the all the products are completely disassembled, and the resultant intermediate products A to C and J are sent to another factory (factory 2) near the DC. In the other factory, on the basis of customer requests, the products X and Y are reassembled from the intermediate products A to C and J in units of machine types, and the products X and Y are sent to the DC.

In addition, as a related art, Patent Document 1 describes a technique that applies a VRP to a vehicle transportation system to set optimum delivery paths and sets an optimum loading pattern to each numbered vehicle of transportation vehicles in consideration of various circumstances which a sales site has in arrangement of vehicle allocations so as to reduce physical distribution costs.

### PRIOR ART DOCUMENTS

### Patent Document

PTL 1: Japanese Patent Application Laid-Open No. 2002-187622

### SUMMARY OF THE INVENTION

### Technical Problem

In the BTS method, since assembly steps are performed until the final assembly step in one factory regardless of customer requests, a large number of mismatches with various customer requests occur in a DC, and prompt responses to an overall demand fluctuation are difficult. Opportunity losses in business or an increase in stocks caused by the difficulty in prompt responses are posed as problems. On the other hand, in the CTO method, since products depending on customer requests are reassembled in a factory near a DC, flexible responses to the customer request can be advantageously achieved. However, since the products are disassembled/reassembled in a plurality of factories, the number of factories disadvantageously increases to increase the costs and elongate delivery LT (lead time).

The Patent Document 1 describes a device for setting loading patterns depending on a sales company. However, in all examples described in Patent Document 1, only combinations are changed within the range of predetermined component configurations (BOM), and the BOM itself cannot be sequentially dynamically reconfigured.

Thus, it is an object of the present invention to provide a product configuration generating device and a generating method therefor in which a BOM itself can be sequentially dynamically reconfigured.

### Solution to Problems

An example of the typical configuration of the present invention is as follows. A product configuration generating device according to the present invention includes a BOM input unit, a variation specification information input unit, a change subject extraction unit, a BOM reconfiguration unit, and a changed BOM output unit. The BOM input unit acquires a BOM of products used at a plurality of sites, the variation specification information input unit accepts, with respect to each component configuration in the BOM, specifications with variations in past demand at or above a given level as variation specification information, the change subject extraction unit, on the basis of the variation specification information, extracts the component configuration to be segmented from the BOM and generates a BOM to be changed, the BOM reconfiguration unit, on the basis of the BOM to be changed, segments and reconfigures the component configuration of the BOM and generates a changed BOM, and the changed BOM output unit outputs the changed BOM.

### Advantageous Effects of the Invention

According to the present invention, a reduction in number of steps in a factory and a reduction in number of opportunity losses in business can be advantageously achieved.

### BRIEF DESCRIPTION OF DRAWINGS

FIG. 1 is a diagram showing a configuration of a production configuration generating device according to a first embodiment of the present invention.

FIG. 2 is a diagram showing a configuration of hardware of the product configuration generating device according to the first embodiment.

FIG. 3 is a diagram for explaining a method of fabricating a product with the product configuration generating device according to the first embodiment.

FIG. 4 is a diagram showing a processing flow of the product configuration generating device in FIG. 1.

FIG. 5 is a diagram showing an example of a configuration of a BOM.

FIG. 6 is a diagram showing a configuration of site-specific fabricatable configuration information input unit.

FIG. 7 is a diagram showing a configuration of a variation specification.

FIG. 8 is a diagram showing a processing flow of a change subject extraction process.

FIG. 9 is a diagram showing a configuration of a BOM to be changed.

FIG. 10 is a diagram showing a processing flow of a BOM reconfiguration process.

FIG. 11 is a diagram showing a configuration of a changed BOM.

FIG. 12 is a diagram showing examples of product fabricating method using the BOM according to conventional methods and a method of the present invention.

FIG. 13 is a diagram for explaining advantages of the present invention in comparison with the conventional method.

FIG. 14 is a diagram showing a processing flow of a product configuration generating device according to a second embodiment of the present invention.

FIG. 15 is a diagram showing a configuration of a shipment specification according to the second embodiment.

FIG. 16 is a diagram showing a configuration of a changed BOM evaluation score in the second embodiment.

FIG. 17 is a diagram showing a display/selection screen of the changed BOM evaluation score in the second embodiment.

### MODE FOR CARRYING OUT THE INVENTION

The present invention provides a product configuration generating device that can sequentially dynamically reconfigure a BOM itself. More specifically, a product configuration generating device in which products configuring the BOM is divided into “partially-finished products (semi-finished products)” each configured by a plurality of components and “items to be disassembled/assembled” each configured by at least one component to make it possible to dynamically endlessly change the BOM depending on situations of a DC. Embodiments of the present invention will be described below in detail.

### First Embodiment

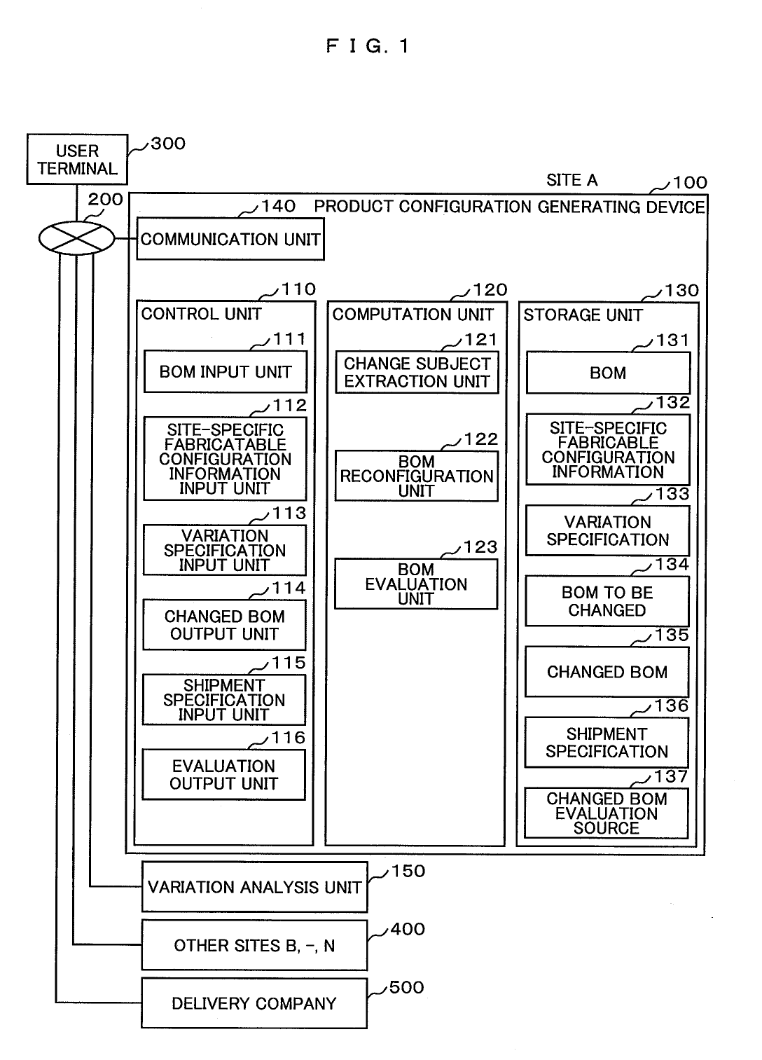

An example of a product configuration generating device according to a first embodiment of the present invention will be described below with reference to FIG. 1 to FIG. 13.

FIG. 1 is a diagram showing a configuration of a product configuration generating device 100 according to the first embodiment of the present invention. The product configuration generating device 100 includes a control unit 110, a computation unit 120, a storage unit 130, and a communication unit 140. Information required in processing in the computation unit 120 can be acquired from a user terminal 300 through a network 200 by using the communication unit 140 as an interface. The control unit 110 of the product configuration generating device includes a BOM input unit 111, a site-specific fabricatable configuration information input unit 112, a variation specification input unit 113, a changed BOM output unit 114, and a shipment specification input unit 115. The computation unit 120 includes a change subject extraction unit 121 and a BOM reconfiguration unit 122. In this specification, a user using the product configuration generating device 100 is defined as a “user”, and a “customer” of a product of the “user” is defined as an “end user”.

The storage unit 130 includes a BOM 131, a site-specific fabricatable configuration information 132, variation specification 133, a BOM to be changed 134, a changed BOM 135, and a shipment specification 136.

An evaluation output unit 116, a BOM evaluation unit 123, and a BOM evaluation score 137 partially configure the product configuration generating device 100 according to a second embodiment (will be described later).

The BOM input unit 111 acquires component configurations (BOM) related to a certain product. The site-specific fabricatable configuration information input unit 112 acquires site-specific fabricatable configuration information. The variation specification information input unit 113, on the basis of the variation specification information, makes it possible to discriminate whether a specification with a variation in past user demand is at or above a given level or lower than the given level. For example, among components configurating a certain product, regardless of various requests of end users, different components are intermingled. That is, components which are always required and, as a result of various requests of end users, and components with a large variation in using rate, in other words, components which are used at a low average using rate, are intermingled. With respect to the specification of components with a variation in past user demand at or above the given level, a variation flag is set.

The change subject extraction unit 121 extracts a product configuration to be segmented from data of the BOM 131 and the variation specification information 133 to generate the BOM to be change 134. The change subject extraction unit 121 checks the site-specified fabricatable configuration information 132 to decide whether a production configuration can be segmented under a fabrication restriction and extracts the product configuration to be segmented.

The BOM reconfiguration unit 122, on the basis of the change subject BOM 134, segments and reconfigures the BOM to generate the changed BOM 135. The change BOM 135 is outputted by the changed BOM output unit 114.

The network 200 is normally a communication network such as a LAN (Local Area Network) managed by an organization of users. The network 200 is not limited to the communication network, and a public communication network such as the Internet or a communication network partially using general public lines such as a WAN (Wide Area Network) or a VPN (Virtual Private Network) may be used.

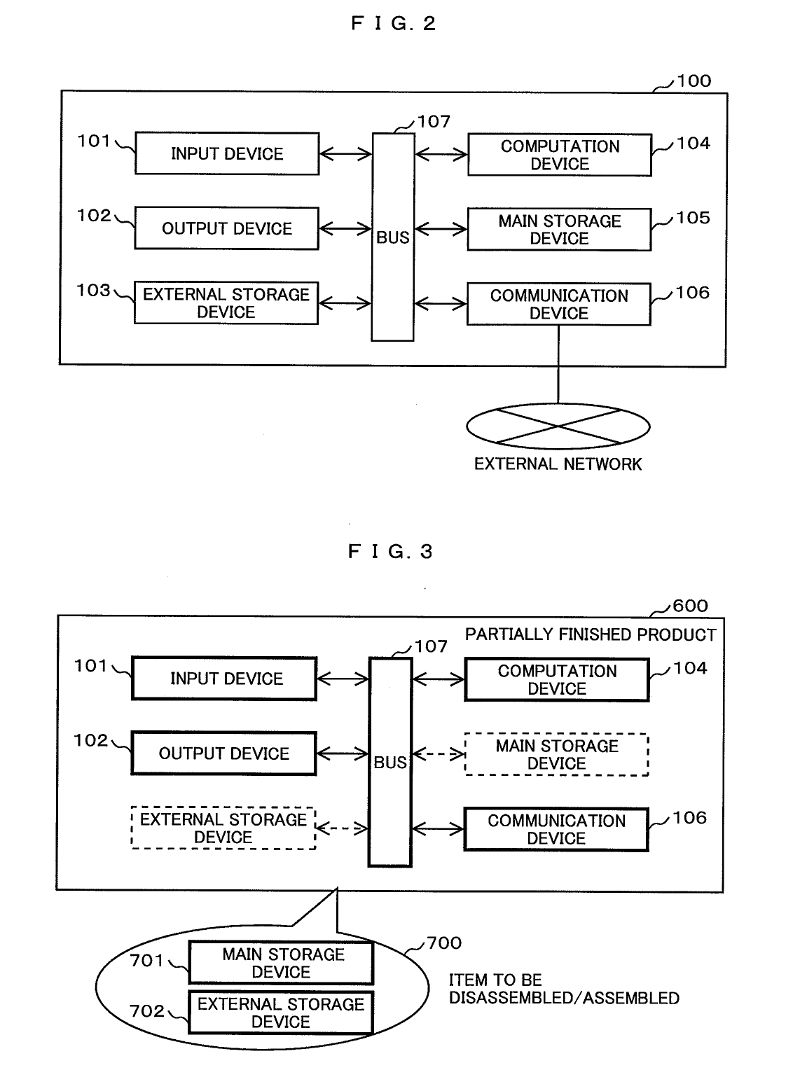

FIG. 2 is a diagram showing a hardware configuration of the product configuration generating device 100 according to the first embodiment.

In this embodiment, the product configuration generating device 100 includes, for example, a computer such as a PC (Personal Computer), a workstation, or a server.

The product configuration generating device 100 includes an input device 101, an output device 102, an external storage device 103, a computation device 104, a main storage device 105, a communication device 106, and a bus 107 connecting these devices to each other. The input device 101 is a device such as a keyboard, a mouse, a touch pen, or another pointing device which accepts an input. The output device 102 is a device such as a display which performs display. The external storage device 103 is a nonvolatile storage device such as a hard disk drive or a flash memory. The computation device 104 is a computation device such as a CPU (Central Processing Unit). The main storage device 105 is a memory device such as a RAM (Random Access Memory). The communication device 106 is a radio communication device which performs radio communication through an antenna or a cable communication device which performs cable communication through a network cable.

The storage unit 130 of the product configuration generating device 100 is achieved with the storage device 105 or the external storage device 103 of the product configuration generating device 100. The control unit 110 and the computation device 120 of the product configuration generating device 100 are achieved with a program which causes a computation device 304 of a product configuration generating device 300 to execute processes. This program is stored in the main storage device 105 or the external storage device 103, loaded on the main storage device 105 in execution, and executed with the computation device 104. The communication unit 140 of a cost review calculation system 100 is achieved with the communication device 106 of the product configuration generating device 100.

FIG. 3 is a diagram for explaining a method of fabricating an information processing device when it is assumed that an “information processing device” having the same hardware structure as that of the product configuration generating device 100 shown in FIG. 2 is an example of a “product”. In this embodiment, a plurality of “components” required to fabricate the information processing device 100 serving as the product shown in FIG. 2 are segmented into two types, i.e., “partially-finished products” 600 and “items to be disassembled/assembled” 700. The partially-finished products 600 configure combinations of a plurality of components which are probably required for the information processing device 100 independently of demands of respective customers, i.e., a component group which is probably commonly used. As the partially-finished products, the input device 101, the output device 102, the computation device 104, a communication device, and the bus 107 are given. On the other hand, the items to be disassembled/assembled 700 configure a component group with a large variation in customer demand. For example, the items correspond to the external storage device 103 and the main storage device 105. For example, since the main storage device 105 normally has a large variation in specification such as arithmetic processing speeds required by end users, the main storage device 105 is classified in the items to be disassembled/assembled 700.

In this case, for descriptive convenience, it is assumed that the information processing devices 100 are fabricated and assembled at two sites (first and second factories) which are geographically distant from each other and that the second factory is near a DC. The partially-finished products 600 are not disassembled/assembled through steps at all sites. On the other hand, the “items to be disassembled/assembled” 700 are disassembled and reassembled at each of the sites.

The information processing devices 100 are fabricated and assembled as products in the first factory (for example, in Japan). Furthermore, the products are disassembled into the partially-finished products 600 and the items to be disassembled/assembled 700. The partially-finished products 600 and the items to be disassembled/assembled 700 are transported to each local factory (for example, the second factory in a local area in Europe, Asia, or the like) which is a sales contact. In the second factory, as reassembling steps, the items to be disassembled/assembled 700 depending on the needs of customers in a local DC are incorporated in the partially-finished products 600, respectively, the information processing device 100 are completed as products, and the products are delivered to the customers.

In the present invention, a “product” and a “component” have a relative relationship, as matter of course. For example, for a certain fabricator or a distributer, the external storage device 103 itself is one “product”, and a component group constituting the external storage device is classified into two groups constituted by “partially-finished products” and “items to be disassembled/assembled”, respectively.

When, as the “product”, an automobile is given, a “normal edition automobile” and a “special edition automobile” are set for each vehicle type. In the “special edition automobile”, a car navigation system is added, tires, antennas, car stereo systems, and the like of the “normal edition automobile” specification are changed into those of the “special edition automobile” specification, specifications or the like for cold regions are equipped, and various components are equipped depending on the needs of customers. In this case, for example, the “car navigation system” itself serves as one “product”.

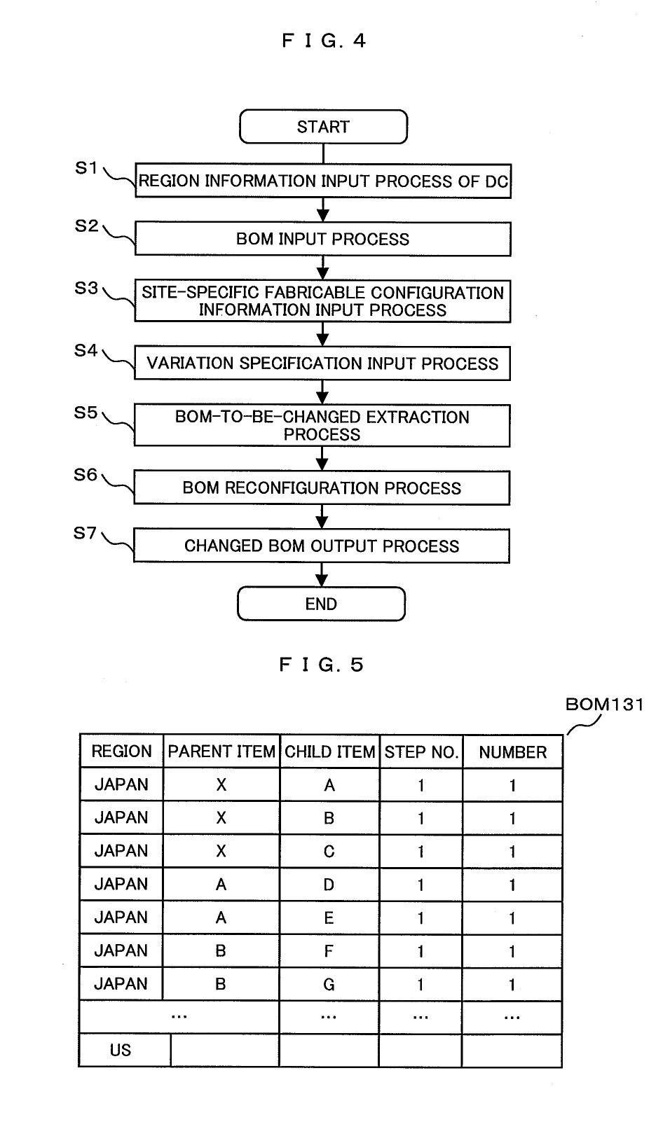

FIG. 4 is a diagram showing a processing flow in the control unit 110 and the computation unit 120 in FIG. 1.

As a region information input unit process (S1) of a DC, information of a region in which a site, i.e., a factory or a DC is located is input. As an input process (S2) of a BOM, the BOM input unit 111 accepts the BOM 131 and stores the BOM 131 in the storage unit 130. As an input process (S3) of a site-specified fabricatable configuration information, the site-specified fabricatable configuration input unit 112 accepts the site-specified fabricatable configuration information 132 and stores the site-specified fabricatable configuration information in the storage unit 130.

As an input process (S4) for a variation specification, the variation specification input unit 113 accepts the variation specification 132 and stores the variation specification 132 in the storage unit 130.

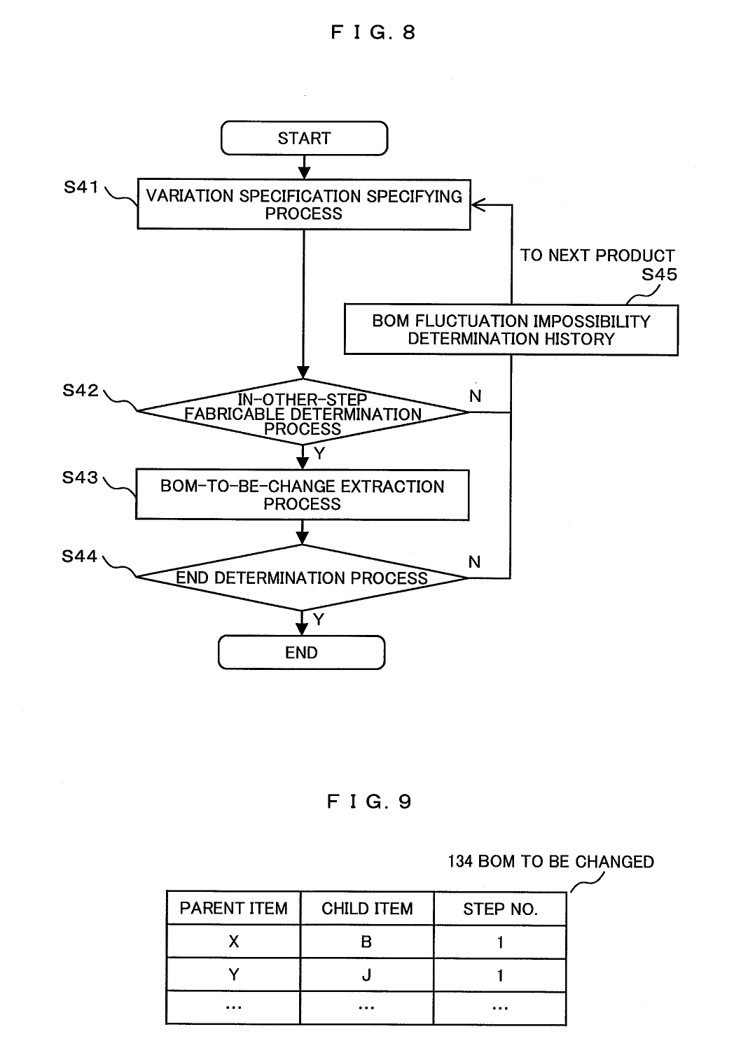

As an extraction process (S5) for a change subject, the change subject extraction unit 121, on the basis of the BOM 131 stored in the storage unit 130, the site-specified fabricatable configuration information 132, and the variation specification 133, (by processes S41 to S44 in FIG. 8 (details thereof will be described later)), extracts a half-finished configuration which should be segmented and can be segmented under a fabricating restriction and stores the extracted change subject BOM 134 in the storage unit 130.

As an extraction BOM reconfiguration process (S6) for a change subject, the BOM reconfiguration unit 122 generates the changed BOM 134 (by processes in S51 to S54 in FIG. 10 (details thereof will be described later)) on the basis of the BOM 131 stored in the storage unit 130 and the BOM to be changed 134 and stores the changed BOM 134 in the storage unit 130.

Finally, as a changed BOM output process (S7), the changed BOM output unit 114 outputs the BOM 131 which are stored in the storage unit 130 to the user terminal 300.

FIG. 5 is a diagram showing a configuration of the BOM 131 received by the BOM input unit 111. In each column of the BOM 131, region information such as Japan, the United

States, Europe, or south-eastern Asia, parent items serving as upper items of a component group constituting products, and child items serving as lower items constituting each of the parent items, step No. representing a specific step in which a configuration is fabricated, and a number which is a number of child items required to constitute a parent item are stored.

According to records of first to third rows, it is understood that a region is Japan, a parent item “X” is configured by one “A”, one “B”, and one “C” and fabricated in step “1”.

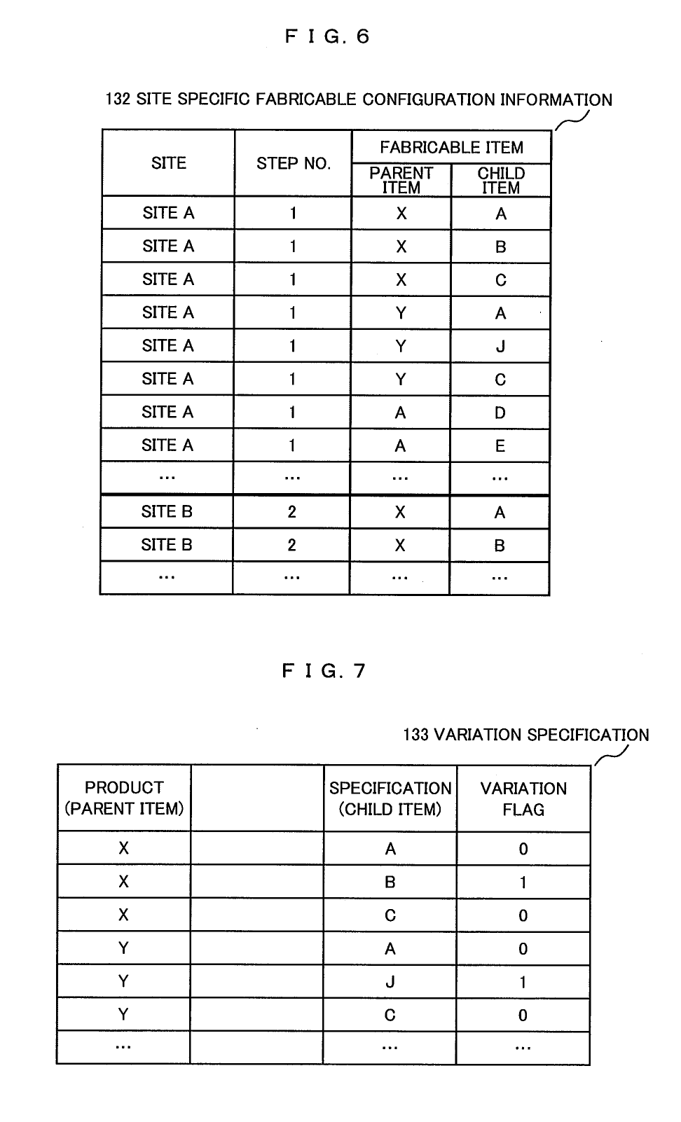

FIG. 6 is a diagram showing a configuration of the site-specified fabricatable configuration information 132 received by the site-specified fabricatable configuration input unit 112. IN each column of the site-specified fabricatable configuration information 132, a site at which each item is produced, step No. representing number counted from the upstream in all fabricating steps, and a fabricatable item representing a specific item which can be fabricated at the site are stored.

According to the record of the first row, it is understood that, at a site “site A”, a step NO. in all the fabricating steps is “1”, fabricating which incorporates a child item “A” in the parent item “X” can be performed.

According to FIG. 5 and FIG. 6, it is also understood that the site “site A” is a factory in Japan.

FIG. 7 is a diagram showing a configuration of the variation specification 133 received by the variation specification input unit 113. In each column of the variation specification 133, products which are parent items, specifications which are child items, and variation flags calculated by checking whether the variation in specification exceeds a tolerance with historical performance analysis or the like are stored. As the tolerance of the variation in specification, for example, an arbitrary value ranging from 10% to 30% is set. When the variation in specification exceeds the tolerance, the variation flag is set to 1. According to the records of the first and second rows, since a specification “A” in the product “X” is not influenced by various requests of end users, in other words, the variation is equal to or lower than the tolerance, the variation flag is set to 0. On the other hand, since a specification “B” is not matched with the various requests of the end users, in other words, the variation exceeds the tolerance, it is understood that the variation flag is set to 1.

FIG. 8 is a diagram showing a sub-processing flow of the change subject extraction process (S4) in the change subject extraction unit 121.

In a variation specification specifying process (S41), a variation specification in each product is specified on the basis of the BOM 131 and the variation specification 133.

In an in-other-step fabricatable determination process (S42), it is determined whether the variation specification specified in the variation specification specifying process (S41) is fabricatable in the later step (step No. 2 in a date example). When the variation specification is fabricatable, the operation shifts to BOM to be changed extraction process (S43). When the variation specification is not fabricatable, the operation shifts to the variation specification specifying process (S41) for the next product.

In the BOM to be changed extraction process (S43), a combination of a parent item and a child item determined to be fabricatable in another step in the in-other-step fabricatable determination process (S42) is stored in the BOM to be changed 134.

Finally, in an end determination process (S44), when another product remains, the operation shifts to the variation specification specifying process (S41). When the processes are finished to all the products, the operation is ended.

Data of combinations of parent items and child items determined not to be fabricatable (N) in the other step in the in-other-step fabricatable determination process (S42) is accumulated as a “BOM fluctuation impossibility determination history” (S45). A user may extract, from the accumulated data, a combination which is determined not to be fabricatable in the other step (N) at a high rate and may be able to examine to make the combination fabricatable in the other step at any site. Alternatively, depending on situations, the in-other-step fabricatable determination process (S42) and (S45) may be omitted.

FIG. 9 is a diagram showing a configuration of the BOM to be changed 134 which is output by the change subject extraction unit 121. A BOM corresponding to a specific specification is extracted as the BOM to be changed 134 and stored. In each column of the BOM to be change 134, parent items and child items are stored.

According to the recording of the first row of the BOM to be change 134, it is understood that a combination of the parent item “X” and the child item “B” fabricated in step NO. “1” corresponds to BOM to be changed.

FIG. 10 is a diagram showing a sub-processing flow of a BOM reconfiguration process (S6) in the BOM reconfiguration unit 121. In this case, the BOM to be change 134 is deleted from the BOM 131, and at the same time, a BOM 131 having a partially-finished product name as a parent is generated.

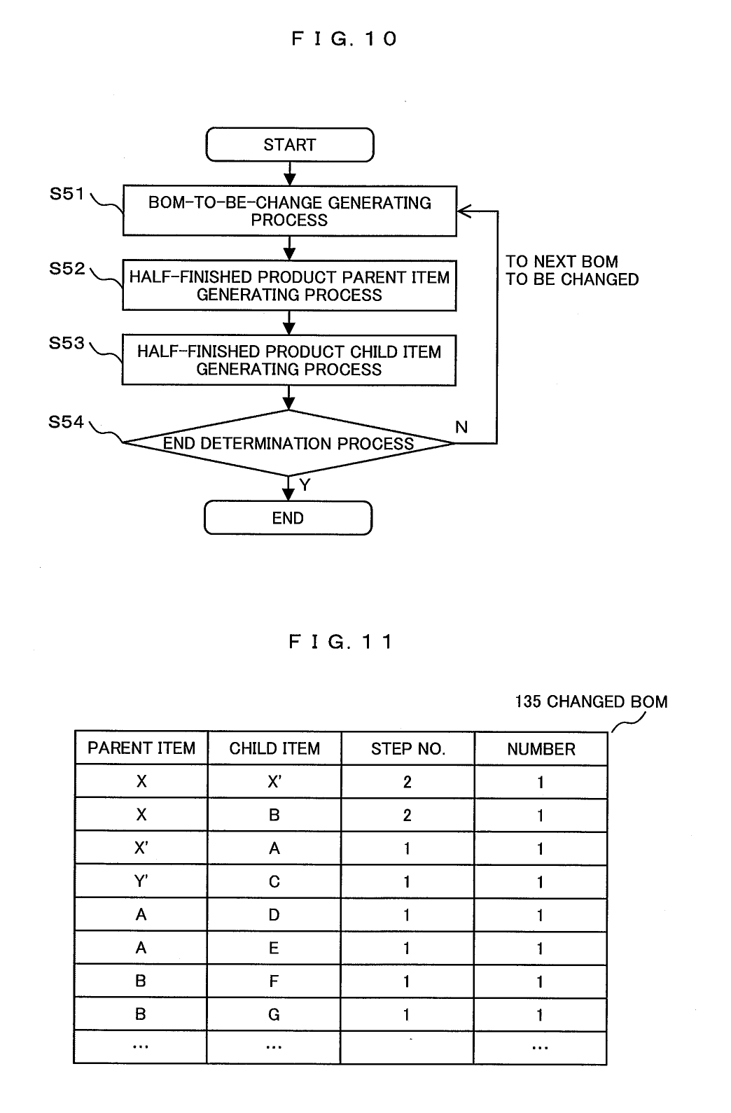

FIG. 11 is a diagram showing a configuration of the changed BOM 135 output by the BOM reconfiguration unit 121. The configuration of the changed BOM 135 is the same as that of the BOM 131 described above. In the BOM reconfiguration process, in any BOM 131 influenced by the deletion of the

BOM to be changed 134, a partially-finished product name representing being a “partially-finished product” is set in the parent item “X” of a child item “B” of the product (“X” in the example in FIG. 9). Then, a new BOM of the product “X” having the set partially-finished product name as a child item is generated.

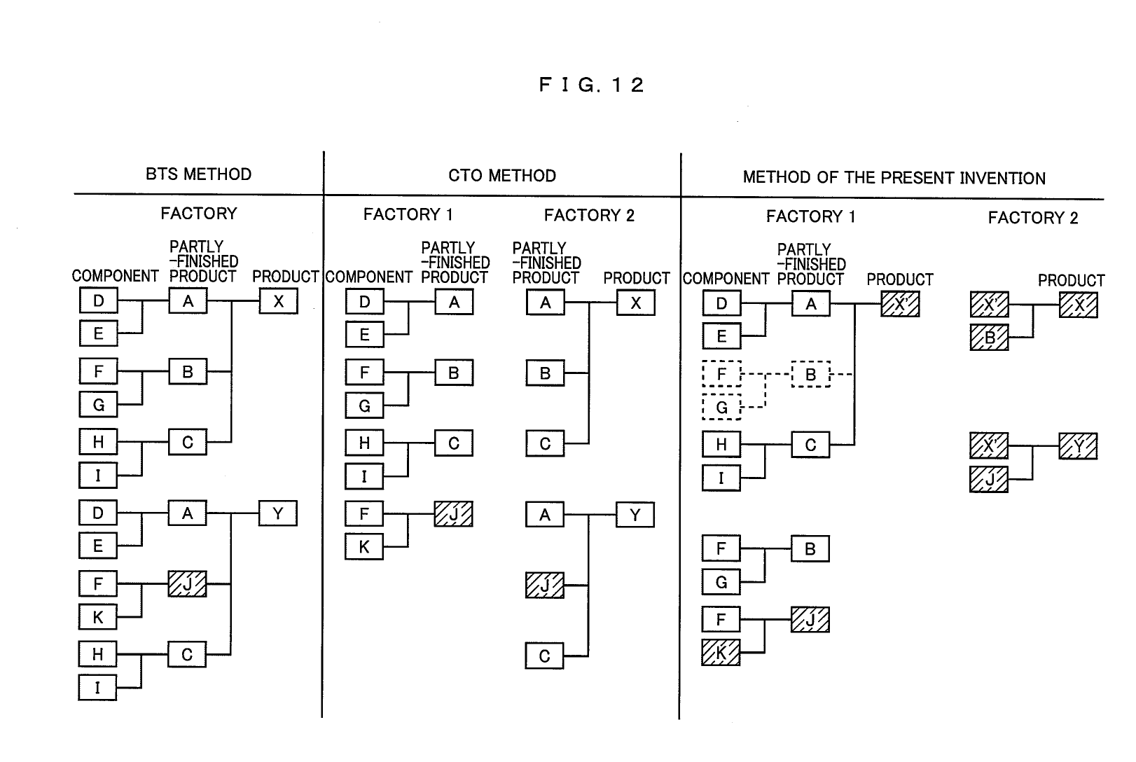

A sub-processing flow of the BOM reconfiguration process (S6) will be described below with reference to FIG. 10, FIG. 11, and a column of a “method of the present invention” in FIG. 12.

In the BOM to be changed generating process (S51), a configuration No. of the BOM stored in the BOM to be changed 134 is changed, and the resultant BOM is generated as a new BOM and stored in the changed BOM 135.

It is understood that the BOM to be changed including the parent item “X”, the child item “B” and the step No. “1” stored in the record of the first row in the BOM to be changed 134 in FIG. 9 is generated and stored as a new BOM including the parent item “X”, the child item “B”, and the step No. “2” as described in the record of the second row in the change BOM 135 in FIG. 11.

In a parent item generating process (S52) for partially-finished product, with respect to a child item of a parent item influenced by the change of the changed BOM 135 described above, a partially-finished product item is set as the parent item. The resultant BOM is generated as a new BOM and stored in the changed BOM 135.

It is understood that the BOM including the parent item “X”, the child item “A” and the step No. “1”, stored in the record of the first row in the BOM 131 in FIG. 5 is generated and stored as a new BOM including a parent item “X′” which is a partially-finished product item, the child item “A”, the step No. “1”, as indicated in the record of the third row in the changed BOM 135 in FIG. 11.

In a partially-finished product item generating process (S53), the partially-finished product name is similarly set to the child item of the parent item influenced by the change of the changed BOM, the step No. is changed, and the BOM is generated as a new BOM and stored in the changed BOM 135.

It is understood that the BOM including the parent item “X”, the child item “A”, and the step No. “1” stored in the record of the first row in FIG. 5 is generated and stored as a new BOM 135 including the parent item “X”, the child item “X′” serving as a partially-finished product item, and the step No. “2” as described in the record of the first row in FIG. 11.

Finally, in an end determination process (S54), when other BOM to be changed remain, the operation shifts to S51. When the processes are finished to all the BOM to be changed, the operation is ended.

With the above processes, the changed BOM 135 can be obtained.

With respect to the changed BOM 135, when a new variation specification having variation wherein the flag is set to 1 occurs thereafter, the changed BOM 135 is replaced with another new BOM 131, and another changed BOM 135 is generated in the same manner as described above to make it possible to sequentially dynamically reconfigure the BOM itself.

An example using the changed BOM 135 will be described with reference to a column of a “method of the present invention” in FIG. 12. In this case, for descriptive convenience, it is assumed that, in the initial BOM 131, the BOM 101 of the initial product “X” and the initial product “Y” are the same as those of the CTO method and equivalents of the “partially-finished product” and the “items to be disassembled/assembled” are not present.

According to the embodiment of the present invention, with respect to the BOM 131 of the product “X”, when the intermediate product “B” has a large variation in specification, the intermediate product “B” becomes an “item to be disassembled/assembled” in the changed BOM 135. More specifically, when the changed BOM 135 to which the embodiment is applied is used, with respect to the product

“X”, a partially-finished product “X′” is fabricated from intermediate products “A” and “C” in factory 1. In addition, as the “item to be disassembled/assembled”, the intermediate product “B” having a large variation in specification is fabricated from components “F” and “G”.

In factory 2, a product “X” having various specifications which can be flexibly suitable for requests of end users and a fluctuation in demand can be fabricated from the partially-finished product “X′” having a small variation and the “item to be disassembled/assembled=“B” having a large variation. Even though a fluctuation in demand of the product, similarly, a new changed BOM 135 is generated by setting intermediate products each having a large variation in specification as the “items to be disassembled/assembled” and setting the remains as “partially-finished products” to obtain the same effect as described above.

Similarly, also with respect to the product “Y”, the partially-finished product “X′” having a small variation is fabricated from the intermediate products “A” and “C” in factory 1. In addition, an “item to be disassembled/assembled=“J” having a large variation in specification is fabricated from components “F” and “K”.

In factory 2, the product “Y” having various specifications which can be flexibly suitable for requests of end users and a fluctuation in demand can be fabricated from the partially-finished product “X′” having a small variation and the “item to be disassembled/assembled=“J” having a large variation.

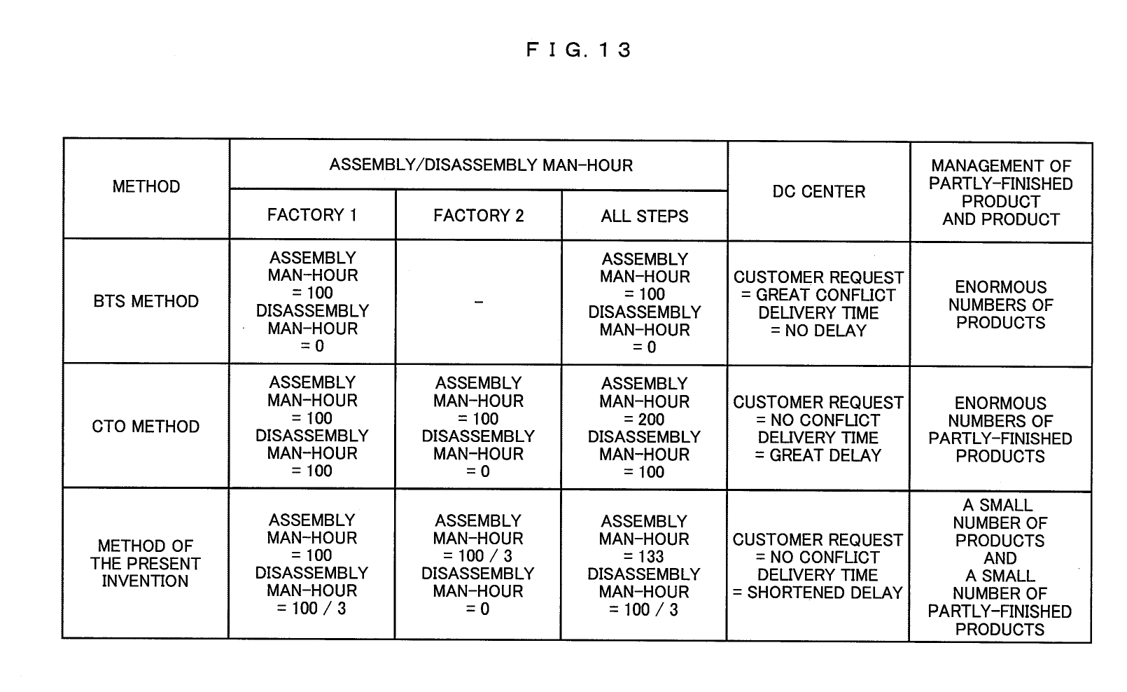

Advantages of the present invention will be described in comparison with the conventional BTS method and CTO method with reference to FIG. 13. In this case, in accordance with the example shown in FIG. 12, it is assumed that products are fabricated in only the factory 1 and directly delivered to a local DC in the BTS method, and all products are fabricated, disassembled/reassembled in factories 1 and 2 and delivered to a local DC in the CTO method. In the method of the present invention, it is assumed that the first embodiment is employed to make ⅓ of all products objects to be disassembled/reassembled in factories 1 and 2.

In the BTS method, assembly man-hours=100 in the factory 1 are entire man-hours, and disassembly man-hours become 0. Similarly, in the CTO method, entire assembly man-hours=200 and disassembly man-hours=100 are given. In contrast to this, in the method of the present invention, entire assembly man-hours≈133 and disassembly man-hours≈33 are given. More specifically, all the man-hours in factories in the method according to the present invention are larger in number than those in the BTS method but considerably smaller in number those in the CTO method.

In the local DC, in the BTS method, delivery time is not delayed, conflict with customer requests becomes great. The BTS method is difficult to cope with an entire fluctuation in demand, and opportunity losses increase. In the CTO method can flexibly cope with various customer requests and an entire fluctuation in demand. However, all products must be reassembled, and the delay in delivery increases.

In contrast to this, in the method according to the present invention, conflict with the customer requests becomes small, flexible and prompt responses to an entire fluctuation in demand can be achieved, and opportunity losses can be reduced.

Furthermore, with respect to management of intermediate products and products, in the BTS method, to cope with various customer requests, the number of products becomes enormous, and costs for inventory management increase. In the CTO method, the number of intermediate products becomes enormous. In contrast to this, in the method according to the present invention, both the number of products and the number of intermediate products decrease, and the inventories can be reduced. More specifically, when optimum “partially-finished products” and optimum “items to be disassembled/assembled” are employed, man-hours and costs in transportation between a factory and a DC can be advantageously reduced. Furthermore, the delay in delivery time can be advantageously expected to be reduced.

In this manner, according to the embodiment, since BOM meeting temporal demands can be automatically generated, a reduction in man-hour in a factory can be expected. In this manner, a reduction in number of opportunity losses (increase in sales) and a reduction in number of inventories can be expected by prompt responses to a fluctuation in demand.

The embodiment described above shows the case in which a BOM is changed to fabricate a product with a large variation in specification in a later step. However, when the product with a large variation in specification is originally fabricated in a latter step, the same processes as described above may be performed to fabricate a product with a small variation in specification in a former step.

A program executed in the product configuration generating device 100 according to the embodiment of the present invention may be provided such that the program is recorded as a file in an installable format or an executable format on a computer readable recording medium such as a CD-ROM (Compact Disc Read Only Memory), a flexible disk (flexible disk), a CD-R (Compact Disc Recordable), or a DVD (Digital Versatile Disc).

Furthermore, the program executed by the product configuration generating device 100 according to the embodiment may be provided such that the program is stored in a computer connected to a network such as the Internet and downloaded through the network. The program executed by the product configuration generating device 100 according to the embodiment may be configured to be provided or delivered a network such as the Internet or provided by being installed in a ROM or the like in advance.

### Second Embodiment

In a second embodiment, in addition to the configuration of the first embodiment, an example of the product configuration generating device 100 having the evaluation output unit 116 and the BOM evaluation unit 123 will be described. The evaluation output unit 116 outputs a BOM evaluation result to a screen. In the BOM evaluation unit 123, for the changed BOM 135 generated by the BOM reconfiguration unit 122, on the basis of the shipment specification 136 input from the shipment specification input unit 115, calculates the evaluation score 137.

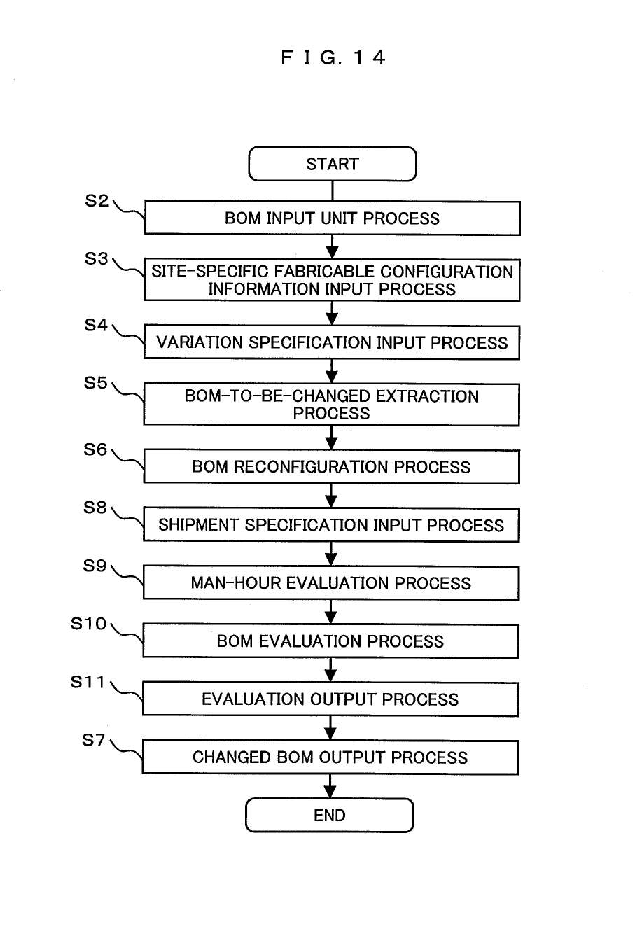

FIG. 14 is a diagram showing an example of a processing flow corresponding to the second embodiment in the control unit 110 and the computation unit 120 in FIG. 1. As in the first embodiment, although the process S1 in FIG. 4 is also required, a description thereof will be omitted.

After the BOM reconfiguration process (S6), the shipment specification input unit 115 performs a shipment specification input process (S8) to acquire the shipment specification 136 such as historical shipment performance.

The BOM evaluation unit 123 evaluates the changed BOM 135. As is apparent from the explanation of the method according to the present invention in FIG. 12 and FIG. 13, when a ratio of fixed specifications in the changed BOM is increased, the degree of satisfaction with customer requests lowers. However, in contrast to this, the “disassembly man-hours” in the steps at all the sites advantageously reduce. Thus, the changed BOM is desired to be evaluated also in consideration of changes in man-hour at all the sites.

First, in the BOM evaluation unit 123, on the basis of the BOM 131 and the changed BOM 135, a man-hour evaluation process (S9) is performed. The BOM evaluation unit 123 calculates a numerical value of a “reduction in man-hour” obtained by comparing the BOM 131 and the changed BOM 135 as the evaluation score 137 and outputs the evaluation score 137 to the evaluation output unit 116 (not shown).

According to the example of the method of the present invention described in FIG. 12 and FIG. 13, in the changed BOM 135, in consideration of the man-hour in the steps at all the sites, of all the specifications, two specifications “A” and “B” are partially-finished products, i.e., the specifications are still fixed. In comparison with an example (of the CTO method) in which the specifications “A” and “B” of the partially-finished product, the man-hours of the present invention are reduced to ⅓.

The BOM evaluation unit 123 performs a BOM evaluation process (S10). More specifically, on the basis of the shipment specification 136, the changed BOM 135 generated by the BOM reconfiguration unit 122 is evaluated, and the changed BOM evaluation score 137 serving as an evaluation result is stored in the storage unit 130.

The evaluation output unit 116 accepts the changed BOM evaluation score 137, displays the changed BOM evaluation score 137, and performs an evaluation output process (S11) which accepts whether an user changes the BOM.

In the changed BOM output process (S7), only BOM determined to be changed in the evaluation output process (S11) are output.

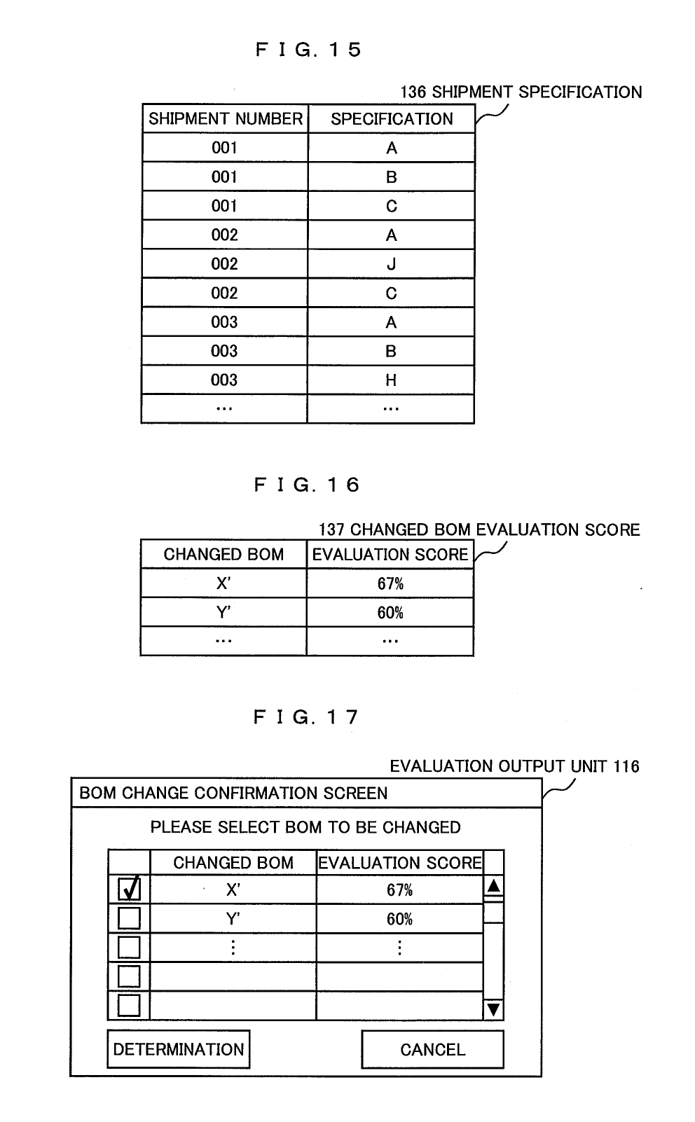

FIG. 15 is a diagram showing a configuration of the shipment specification 136 which received by the shipment specification input unit 115. In the shipment specification 136, a shipment number representing a unit of shipment for a customer and a specification representing a specification (child item) included in the shipment at that time are stored.

According to the records of the first to third rows of the shipment specification 136, is understood that the shipment of shipment number “001” is constituted by specifications “A”, “B”, and “C”.

FIG. 16 is a diagram showing a configuration of the changed BOM evaluation score 137 generated by the BOM evaluation unit 123. In the column of the changed BOM, each item set as a partially-finished product item by the changed BOM 135 is stored, in the evaluation score column, a calculated result, i.e., how many shipment specifications are satisfied by the BOM set as the partially-finished product item, is stored. An example of evaluation score calculation will be described with reference to examples in FIG. 11, FIG. 15, and FIG. 16.

As described in the records of the third and fourth rows of the changed BOM 135 in FIG. 11, the partially-finished item “X′” is constituted by the child items “A” and “C”. Since each of shipment numbers “001” and “002” of the shipment specification 136 in FIG. 15 include the specifications “A” and “C”, it can be determined that the shipment numbers “001” and “002” can satisfy the shipment specification with the partially-finished product item “X′”. On the other hand, regarding to the shipment number “003” of the shipment specification 136 in FIG. 15, an item equivalent to the “C” in “001” and “002” is changed into “H”. More specifically, since the shipment number “003” includes

“A” but does not include “C”, it can be determined the shipment number “003” cannot satisfy the shipment specification with the partially-finished item “X′”. Thus, an evaluation score can be calculated by the following expression (1).

Evaluation score=satisfiable case/(satisfiable case+unsatisfiable case) (1)

In the above example, the shipment specification can be satisfied in two cases, and the shipment specification cannot be satisfied in one case. For this reason, the evaluation score is 67%. On the basis of the calculational expression, as described in the record of the first row in FIG. 16, the evaluation score of the changed BOM “X′” can be set as “67%”. Similarly, changed BOM “Y′” have an evaluation score of “60%”.

FIG. 17 is a diagram showing a screen displayed on the evaluation output unit 116 on the basis of the changed BOM evaluation score 137. As the screen, a screen on which each of the evaluation score is displayed and one of the changed BOM can be selected by a user is employed.

With respect to the advantages of the “reduction in man-hour”, as described in the columns of the method according to the present invention in FIG. 13, assembly man-hours and disassembly man-hours at each fabrication site and assembly man-hours and disassembly man-hours in all the steps are configured to be able to be displayed on the screen displayed on the evaluation output unit 116.

The evaluation output unit 116 may be designed such that a user can selectively display evaluation about a change in man-hour or only evaluation based on shipment specification.

Alternatively, the evaluation output unit 116, on the basis of the BOM 131 in FIG. 5 and data of the changed BOM 135 in FIG. 11, as described in the columns of the method according to the present invention in FIG. 12, is configured such that mutual relationships between components, intermediate products, “partially-finished products”, and “items to be disassembled/assembled” can be displayed on the screen to make a user possible to easily make a determination on the basis of screen information.

According to the embodiment, since the intention of a user can be reflected in the processes of automatically generating a changed BOM, the changed BOM matched with the needs of the user can be generated. In this manner, a reduction in man-hour in a factory, a reduction in opportunity loss (increase in sales) caused by prompt responses to a fluctuation in demand, and a reduction in number of inventories can be expected.

According to the embodiment, in the processes of automatically generating a changed BOM, the advantages and influences of the changed BOM can be checked by a user in advance. For this reason, a changed BOM matched with the needs of the user can be generated.

In the above embodiments, component groups constituting products are classified into two types, i.e., “partially-finished products” and “items to be disassembled/assembled”. However, by also reflecting region information or the like, the component groups may be classified into three or more types.

The present invention is not directly limited to the above embodiments, and can be embodied by modifying constituent elements in an execution phase without departing from the spirit and scope of the invention. Various inventions can be formed by appropriate combinations of the plurality of constituent elements disclosed in the embodiments. For example, some constituent elements can be deleted from all the constituent elements described in the embodiments. Furthermore, constituent elements of different embodiments may be appropriately combined to each other.

### REFERENCE SIGNS LIST

100: product configuration generating device, 110: control unit, 120: computation unit, 130: storage unit, 140: communication unit, 111: BOM input unit, 112: site-specified fabricatable configuration input unit, 113: variation specification input unit, 114: changed BOM output unit, 115:

shipment specification input unit, 116: evaluation output unit, 121: change subject extraction unit, 122: BOM reconfiguration unit, 123: BOM evaluation unit, 200: network, 300: user terminal, 600: partially-finished product, 700: item to be disassembled/assembled.

1. A product configuration generating device comprising:
a BOM input unit;
a variation specification information input unit;
a change subject extraction unit;
a BOM reconfiguration unit; and
a changed BOM output unit,
wherein the BOM input unit acquires a BOM of products used at a plurality of sites,
wherein the variation specification information input unit accepts, with respect to each component configuration in the BOM, specifications with variations in past demand at or above a given level as variation specification information,
wherein the change subject extraction unit, on the basis of the variation specification information, extracts the component configuration to be segmented from the BOM and generates a BOM to be changed,
wherein the BOM reconfiguration unit, on the basis of the BOM to be changed, segments and reconfigures the component configuration of the BOM and generates a changed BOM, and
wherein the changed BOM output unit outputs the changed BOM.

2. The product configuration generating device according to claim 1,
wherein the product in the changed BOM includes partially-finished products and items to be disassembled/assembled,
wherein the partially-finished product is constituted by the plurality of components which do not correspond to the variation specification information, and
wherein the item to be disassembled/assembled is the component corresponding to the variation specification information.

3. The product configuration generating device according to claim 2,
wherein the partially-finished product is not an object to be disassembled/reassembled throughout the steps in fabricating and assembling the products at the plurality of sites, and
wherein the item to be disassembled/assembled is an object to be disassembled/reassembled between the plurality of sites.

4. The product configuration generating device according to claim 2, further comprising
a site-specified fabricatable configuration information input unit,
wherein the site-specified fabricatable configuration information input unit, with respect to the plurality of sites, acquires information of the fabricatable component configuration in units of sites, and
wherein the change subject extraction unit, on the basis of the information of the component configuration, generates the BOM to be changed from the BOM.

5. The product configuration generating device according to claim 2, further comprising:
a BOM evaluation unit; and
an evaluation output unit,
wherein the BOM evaluation unit, on the basis of the BOM or the changed BOM, displays assembly man-hours and disassembly man-hours at each of the sites related to the product and assembly man-hours and disassembly man-hours in all steps on a screen.

6. The product configuration generating device according to claim 5,
wherein the BOM evaluation unit, on the basis of the BOM or the changed BOM, displays mutual relationships between the components related to the product, the partially-finished product, and the items to be disassembled/assembled on the screen.

7. The product configuration generating device according to claim 4,
wherein the BOM to be changed generating unit changes a configuration No. of BOM stored as the BOM to be changed, generates the BOM as a new BOM, and stores the new BOM in the changed BOM.

8. The product configuration generating device according to claim 7,
wherein the BOM to be changed generating unit, with respect to a child item of a parent item influenced by the change of the changed BOM, sets a partially-finished product item to the parent item, generates BOM as a new BOM, and stores the new BOM in the changed BOM.

9. The product configuration generating device according to claim 8,
wherein a partially-finished product name is set to the child item of the parent item influenced by the change of the changed BOM, the step No. of the child item is changed, generated a new BOM, and the new BOM is stored in the changed BOM.

10. The product configuration generating device according to claim 1,
wherein the site-specified fabricatable configuration information, with respect to the component configuration, includes information related to fabrication restriction at each of the sites, and
wherein the change subject extraction unit has a function that checks the site-specified fabricatable configuration information to determine whether the component configuration can be segmented under the fabrication restriction, and extracts the product configuration to be segmented.

11. The product configuration generating device according to claim 1, further comprising:
a shipment specification input unit;
a BOM evaluation unit; and
an evaluation output unit,
wherein the BOM evaluation unit, with respect to the changed BOM generated by the BOM reconfiguration unit, calculates an evaluation score on the basis of a shipment specification input from the shipment specification input unit, and
wherein the evaluation output unit, on the basis of the BOM and the changed BOM, displays mutual relationships between the components related to the product, the partially-finished product, and the items to be disassembled/assembled together with the evaluation score on a screen.

12. A method of generating a product configuration by a product configuration generating device, comprising steps of:
acquiring BOM of products used at a plurality of sites from a BOM input unit,
accepting, with respect to each component configuration of the BOM, specifications with variations in past demand at or above a given level as variation specification information,
extracting, on the basis of the variation specification information, the component configuration to be segmented from the BOM and generating a BOM to be changed,
segmenting and reconfiguring, on the basis of the BOM to be changed, the component configuration of the BOM and generating a changed BOM, and
outputting the changed BOM.

13. The method of generating a product configuration according to claim 12,
wherein a plurality of components constituting the product are classified into partially-finished products each configured by the plurality of components which do not correspond to the variation specification information, and items to be disassembled/assembled corresponding to the variation specification information.

14. The method of generating a product configuration according to claim 13,
wherein, on the basis of the BOM or the changed BOM, mutual relationships between the components related to the product, the partially-finished product, and the items to be disassembled/assembled are displayed on a screen of a BOM evaluation unit.

15. A program causing a computer to function as:
a BOM input unit that acquires a BOM used in fabrication of products at a plurality of sites,
a variation specification information input unit that accepts, with respect to each component configuration of the BOM, specifications with variations in past demand at or above a given level as variation specification information,
a change subject extraction unit that extracts, on the basis of the variation specification information, the component configuration to be segmented from the BOM and generates a BOM to be changed,
a BOM reconfiguration unit that segments and reconfigures, on the basis of the BOM to be changed, the component configuration of the BOM and generates a changed BOM, and
a change BOM output unit that outputs the changed BOM.
